(19) United States
(12) Patent Application Publication
(10) Pub. No.: US 2023/0072587 A1
(43) Pub. Date: Mar. 9, 2023

(54) METHOD FOR MONITORING A COMPONENT OF AN EFFECT CHAIN

(71) Applicant: Robert Bosch GmbH, Stuttgart (DE)

(72) Inventors: Hans-Leo Ross, Lorsch (DE); Lucas Heil, Untergruppenbach (DE)

(21) Appl. No.: 17/823,990

(22) Filed: Sep. 1, 2022

(30) Foreign Application Priority Data
Sep. 3, 2021 (DE) 10 2021 209 689.1

(51) Int. Cl. H04L 9/32; B60W 50/04

(52) U.S. Cl. CPC H04L 9/3265; B60W 50/04; H04L 2209/84

(57) ABSTRACT

A system for monitoring a component of an effect chain for an at least partially automated driving function of a motor vehicle. The system includes: a processor; one or more memory blocks, an input, set up to receive output data output by the component;

computer-executable instructions, executable by the processor in order to implement one or more enclaves, using the one or more memory blocks, the one or more enclaves including a certificate enclave, which is set up to create a certificate for the component of the effect chain; an output, set up to output the certificate to the component, the certificate enclave being set up to check the output data received following output of the certificate, on the basis of the certificate, in order to output a check result, and a trigger device, set up to trigger a security action based on the check result.

### CROSS REFERENCE

The present application claims the benefit under 35 U.S.C. § 119 of German Patent Application No. DE 10 2021 209 689.1 filed on Sep. 3, 2021, which is expressly incorporated herein by reference in its entirety.

### FIELD

The present invention relates to a system for monitoring a component of an effect chain for an at least partially automated driving function of a motor vehicle, a method for monitoring a component of an effect chain for an at least partially automated driving function of a motor vehicle, a computer program, and a machine-readable storage medium.

### BACKGROUND INFORMATION

German Patent Application No. DE 11 2017 001 853 T5 of the PCT Patent Application No. WO 2017/210145 describes a method for providing attestation keys in secure enclaves.

### SUMMARY

A problem addressed by the present invention includes that of providing for the efficient monitoring of a component of an effect chain for an at least partially automated driving function of a motor vehicle.

This problem may be solved by features of the present invention. Advantageous embodiments of the present invention are disclosed herein.

According to a first aspect of the present invention, a system is provided for monitoring a component of an effect chain for an at least partially automated driving function of a motor vehicle.

According to an example embodiment of the present invention, the system comprises:

a computer platform, comprising:

a processor,

one or more memory blocks,

an input, which is set up to receive output data output by the component,

computer-executable instructions, which are executable by the processor in order to implement one or more enclaves, using the one or more memory blocks,

the one or more enclaves including a certificate enclave, which is set up to create a certificate for the component of the effect chain,

an output, which is set up to output the certificate to the component,

the certificate enclave being set up to check the output data received following output of the certificate, on the basis of the certificate, in order to output a check result, and

a trigger device, which is set up to trigger a security action on the basis of the check result.

According to a second aspect of the present invention, a method is provided for monitoring a component of an effect chain for an at least partially automated driving function of a motor vehicle, using the system according to the first aspect. According to an example embodiment of the present invention, the method comprises the following steps:

creating a certificate for the component of the effect chain by way of the certificate enclave,

outputting the certificate to the component by way of the output, receiving output data output by the component by way of the input,

checking the output data received following output of the certificate, on the basis of the certificate, by way of the certificate enclave, in order to output a check result,

triggering a security action based on the check result, by way of the trigger device.

According to a third aspect of the present invention, a computer program is provided which comprises commands that, in response to the execution of the computer program by the system according to the first aspect, cause the system to carry out a method according to the second aspect.

According to a fourth aspect of the present invention, a machine-readable storage medium is provided, on which the computer program according to the third aspect is stored.

According to example embodiments of the present invention, the above problem may be solved by implementing one or more enclaves, each of which assumes different functions for monitoring the component of the effect chain for an at least partially automated driving function of a vehicle. One of the enclaves has a certificate-creating function. In other words, this enclave is set up to create a certificate for the component of the effect chain.

Steps that are carried out within an enclave, i.e., by way of an enclave, are particularly trustworthy. This means that the corresponding results may be trusted. The corresponding results thus have a high degree of trustworthiness. This is due in particular to the fact that an enclave is a region within an address space (memory block or memory blocks) of a process, the region being specially protected by a CPU, i.e., by the processor, wherein all direct accesses to the region, even by privileged processes, are controlled and/or prevented by the CPU. This special protection of the region includes, for example, a transparent memory encryption, in particular with integrity protection. In addition to the conventional tasks of the enclave, it may in particular also, in accordance with the concept described here, verifiably ensure the correctness of a function, of a process and/or of a sequential order and/or chronological order. If it is no longer possible, for example, for the enclave to determine this, then the enclave will no longer trigger the watchdog, for example, thereby causing the watchdog to trigger the security action.

This means that it is not generally possible for the certificate created by the certificate enclave to be manipulated by malicious software. In this way, based on the certificate, for example, a function that is to be executed and/or provided by the component may be cryptographically secured in an efficient manner. Thus, for example, it is possible to determine from the output data whether said data have been manipulated, in which case a security action may be triggered, for example.

It is thus possible for manipulations of the component and/or of the output data, for example, to be efficiently detected, such that ultimately the component of the effect chain for the at least partially automated driving function may be monitored efficiently.

For example, the certificate is a fragment of a key, which is supplemented by the component with an item of application-specific information from at least two sources, for example, in order to complete the key, which is also known as the aggregate key. The certificate enclave checks this aggregate key.

In one specific example embodiment of the present invention, the effect chain is implemented in an infrastructure. This brings about the technical advantage of, for example, enabling the effect chain to be implemented efficiently.

In one specific example embodiment of the present invention, it is provided that the effect chain is implemented in the vehicle. This brings about the technical advantage of, for example, enabling the effect chain to be implemented efficiently.

In one specific example embodiment of the present invention, the effect chain is partially implemented in an infrastructure and is partially implemented in the vehicle. This brings about the technical advantage of, for example, enabling the effect chain to be implemented efficiently.

In one specific example embodiment of the present invention, a component within the meaning of the description is a vehicle component or an infrastructure component. In other words, a component may be part of the vehicle or part of the infrastructure. In other words, in particular, the component may be included in the vehicle or in the infrastructure.

Since an enclave within the meaning of the description is able to perform in particular secure actions, the enclave may also be described as a secure enclave. For example, an enclave is implemented on the basis of the programming reference Intel® Software Guard Extensions (SGX) or ARM® TrustZone.

According to one specific example embodiment of the present invention, it is provided that the one or more enclaves include a processing unit enclave, which is set up to implement a processing unit.

This may bring about a technical advantage that, for example, the implemented processing unit is a functionally secure processing unit.

In one specific example embodiment of the present invention, it is provided that the processing unit is set up to provide a lockstep function.

This may bring about a technical advantage of, for example, enabling a lockstep function to be provided efficiently.

Within the meaning of the description, the term “lockstep” describes a method for fault tolerance and/or error recognition in the hardware of the computer platform. The term “lockstep” is understood by a person skilled in the field of computer technology, so there is no need for further explanation in this regard.

In one specific example embodiment of the present invention, it is provided that the one or more enclaves include a time trigger enclave, which is set up to provide a time trigger function.

This may bring about the technical advantage of, for example, enabling a time trigger function to be provided efficiently. Such a time trigger function thus provides a secure time trigger.

In one specific example embodiment of the present invention, it is provided that the one or more enclaves include a watchdog enclave, which is set up to provide a watchdog function.

This may bring about a technical advantage of, for example, enabling a watchdog function to be provided efficiently.

A watchdog within the meaning of the description denotes a function for failure recognition and/or for recognition and/or detection of a malfunction.

In one specific example embodiment of the present invention, it is provided that the one or more enclaves include an authentication management enclave, which is set up to provide an authentication management function.

This may bring about a technical advantage of, for example, enabling an authentication management function to be provided efficiently.

In one specific example embodiment of the present invention, it is provided that the authentication management enclave is set up to provide a key management function.

This may bring about a technical advantage of, for example, enabling a key management function to be provided efficiently.

In one specific example embodiment of the present invention, it is provided that the key management function is set up to provide a PUF for key management.

This may bring about a technical advantage of, for example, enabling the keys to be managed efficiently.

The abbreviation “PUF” stands for “physical unclonable function” or “physically unclonable function”, which denote structures in the hardware of the computer platform that are used to enable unique identification of the semiconductor and/or to secure keys for cryptographic processes. Using the PUF involves, for example, producing a cryptographic key, such as an AES key, for example, and/or one or more authentications in the challenge/response method, and/or creating one or more authentication certificates for the component and/or for the one or more enclaves.

In one specific example embodiment of the present invention, it is provided that the one or more enclaves include a test generator enclave, which is set up to provide a test generator function for testing the component, in particular for testing the component during runtime.

This may bring about a technical advantage of, for example, enabling the component to be tested efficiently, in particular to be tested efficiently during runtime.

In one specific example embodiment of the present invention, it is provided that the one or more enclaves include a memory enclave, which is set up to provide a memory function for storing cryptographic data.

This may bring about a technical advantage of, for example, enabling cryptographic data to be stored efficiently.

In one specific example embodiment of the present invention, it is provided that the computer platform is designed as an ASIC.

This may bring about a technical advantage of, for example, enabling the computer platform to be implemented efficiently. The abbreviation “ASIC” stands for “application-specific integrated circuit”.

According to one specific example embodiment of the present invention, it is provided that the input is set up to receive configuration data for configuring the computer platform, the processor being set up to configure the computer platform on the basis of the configuration data, in particular during runtime.

This may bring about a technical advantage of, for example, enabling the computer platform to be configured efficiently, in particular to be configured efficiently during runtime.

In one specific example embodiment of the present invention, it is provided that the processor is set up to configure the computer platform on the basis of the configuration data only if they are signed with a valid signature.

This may bring about a technical advantage of, for example, enabling a misuse of this configuration option to be prevented efficiently, in particular to be prevented efficiently during runtime. This means that the processor only accepts configuration data that are signed with a valid signature. This means that the processor is set up to check the validity of a signature of the configuration data. For example, a public key matching the valid private key with which the configuration data were signed is stored in one or more memory blocks.

In other words, the public key may be stored in the computer platform.

In one specific example embodiment of the present invention, it is provided that the check includes establishing whether the output data include the first certificate and/or a component certificate that was created using the first certificate, so the first check result indicates what type of certificate is included in the output data.

This may bring about a technical advantage of, for example, enabling the output data to be checked efficiently.

According to one specific example embodiment of the present invention, it is provided that the check includes establishing whether the output data were received within a predetermined time interval following output of the certificate, so the check result indicates whether the output data were received within a predetermined time interval following output of the certificate.

This may bring about a technical advantage of, for example, enabling the check to be carried out efficiently.

For example, it is provided that, if the check result indicates that the output data include the certificate and/or a component certificate that was created using the certificate, the security action is not triggered, i.e., no security action is triggered. Otherwise, it is provided that, for example, the security action is triggered.

For example, it is provided that no security action is triggered if the check result indicates that the output data were received within the predetermined time interval following output of the certificate. Otherwise, it is provided that, for example, a security action is triggered.

According to one specific example embodiment of the present invention, it is provided that the security action is an element selected from the following group of security actions: rejecting the output data, rejecting an output data flow from the component, rejecting a data packet comprising the output data, rejecting the component as a source of information.

This may bring about a technical advantage of, for example, enabling particularly suitable security actions to be provided.

If the term security action is used in the singular form, it should always be interpreted to include the plural, and vice versa. This means in particular that a plurality of security actions may be triggered, for example.

According to one specific example embodiment of the present invention, it is provided that the component is an element selected from the following group of components: sensor, RSU, ICU, VCU, actuator, surround sensor, main control unit, actuator control unit, processor, communication interface, actuator sensor, storage medium, transmission medium, data processor.

This may bring about a technical advantage of, for example, enabling particularly important components of the effect chain to be monitored.

The abbreviation “ICU” stands for “instruction cache unit”. An instruction cache is, for example, a special cache memory for the temporary storage of instructions.

The abbreviation “VCU” stands for “vehicle control unit”.

The abbreviation “RSU” stands for “roadside unit”. The following terms can also be used synonymously instead of RSU: roadside unit, roadside infrastructure unit, communications module, roadside communications module, roadside radio unit, roadside transmission station.

According to one specific example embodiment of the present invention, it is provided that the method according to the first aspect is a computer-implemented method.

An at least partially automated driving function may drive the vehicle in an at least partially automated manner.

The phrase “at least partially automated driving” encompasses one or more of the following cases: assisted driving, partially automated driving, highly automated driving, fully automated driving. The phrase “at least partially automated” thus encompasses one or more of the following terms: assisted, partially automated, highly automated, fully automated.

Assisted driving means that a driver of the vehicle is always responsible for either the lateral or the longitudinal guidance of the vehicle. The other driving task (i.e., controlling the longitudinal or lateral guidance of the vehicle) is performed automatically. In other words, when the vehicle is driven in an assisted manner, either the lateral or the longitudinal guidance is controlled automatically.

Partially automated driving means that in a specific situation (for example: driving on a freeway, driving in a parking lot, overtaking an object, driving within a lane defined by lane markers) and/or for a certain period of time, a longitudinal and lateral guidance of the vehicle are controlled automatically. A driver of the vehicle does not have to manually control the longitudinal and lateral guidance of the vehicle. However, the driver must constantly monitor the automatic control of the longitudinal and lateral guidance in order to be able to intervene manually if necessary. The driver must be ready to take over full control of the vehicle at any time.

Highly automated driving means that for a certain period of time in a specific situation (for example: driving on a freeway, driving in a parking lot, overtaking an object, driving within a lane defined by lane markers), a longitudinal and lateral guidance of the vehicle are controlled automatically. A driver of the vehicle does not have to manually control the longitudinal and lateral guidance of the vehicle. The driver does not have to constantly monitor the automatic control of the longitudinal and lateral guidance in order to be able to intervene manually if necessary. Where necessary, a takeover request to take over control of the longitudinal and lateral guidance is output to the driver automatically, in particular with an adequate lead time. Therefore, the driver must be potentially able to take over control of the longitudinal and lateral guidance. Limits to the automatic control of lateral and longitudinal guidance are recognized automatically. In a highly automated driving mode, it is not possible to bring a vehicle automatically to a minimal risk condition in every starting situation.

Fully automated driving means that in a specific situation (for example: driving on a freeway, driving in a parking lot, overtaking an object, driving within a lane defined by lane markers), a longitudinal and lateral guidance of the vehicle are controlled automatically. A driver of the vehicle does not have to manually control the longitudinal and lateral guidance of the vehicle. The driver does not have to monitor the automatic control of the longitudinal and lateral guidance in order to be able to intervene manually if necessary. Before automatic control of the lateral and longitudinal guidance comes to an end, the driver is automatically requested to take over the driving task (controlling the lateral and longitudinal guidance of the vehicle), in particular with an adequate lead time. If the driver does not take over the driving task, the vehicle is automatically returned to a minimal risk condition. Limits to the automatic control of lateral and longitudinal guidance are recognized automatically. In all situations, it is possible to return automatically to a minimal risk system condition.

System features follow in particular from corresponding method features, and vice versa. In other words, in particular, technical functionalities of the system according to the first aspect follow by analogy from corresponding technical functionalities of the method according to the second aspect, and vice versa.

According to one specific example embodiment of the present invention, an at least partially automated driving function is an element selected from the following group of at least partially automated driving functions: traffic jam assist function, parking assist function, lane-keeping assist function, overtaking assist function, longitudinal guidance function, lateral guidance function, longitudinal and lateral guidance function.

This may bring about a technical advantage of, for example, enabling particularly suitable at least partially automated driving functions to be selected.

According to one specific example embodiment of the present invention, a surround sensor within the meaning of the description is one of the following surround sensors: radar sensor, LiDAR sensor, ultrasonic sensor, video sensor, magnetic field sensor, capacitive sensor, temperature sensor, moisture sensor, humidity sensor, audio sensor, and infrared sensor.

In accordance with one specific example embodiment of the present invention, the component of the effect chain receives the certificate and integrates it into its nominal function, for example, i.e., in particular the basic function, such that the corresponding output data of the component include, for example, the corresponding received certificate and/or a component certificate that was created using the received certificate. Correct certificates may only be generated by the components if, for example, the enclave certificate has been received and is created by the (external) component using a known reference with time stamp, etc. The enclave checks the correctness of the component certificate and the timeliness, for example.

According to one specific example embodiment of the present invention, it is provided that an application that is executed by the component receives the first and/or the second certificate from the corresponding enclave, the certificate(s) being supplemented with, for example, application-specific information and/or a time stamp at redundant points in the application, for example. These data are made available to the enclave or enclaves as output data within a defined time frame, for example, for checking.

According to one specific example embodiment of the present invention, output data include environment data that represent an area around the vehicle. According to one specific embodiment, output data include an object list that indicates objects in the area around the vehicle.

According to one specific example embodiment of the present invention, the components of the effect chain generate application-specific information, as specified by the enclaves, which has to be reported back to the enclave within the correct time frame.

The specific embodiments and exemplary embodiments described in the description may be combined with one another in any way, even if that is not explicitly described.

Exemplary embodiments of the present invention are shown in the figures and explained in more detail in the following description.

### BRIEF DESCRIPTION OF THE DRAWINGS

FIG. 1 shows a system for monitoring a component of an effect chain for an at least partially automated driving function of a vehicle, according to an example embodiment of the present invention.

FIG. 2 shows a flow chart of a method for monitoring a component of an effect chain for an at least partially automated driving function of a motor vehicle, according to an example embodiment of the present invention.

FIG. 3 shows a machine-readable storage medium, according to an example embodiment of the present invention.

FIG. 4 shows a plurality of enclaves, according to an example embodiment of the present invention.

### DETAILED DESCRIPTION OF EXAMPLE EMBODIMENTS

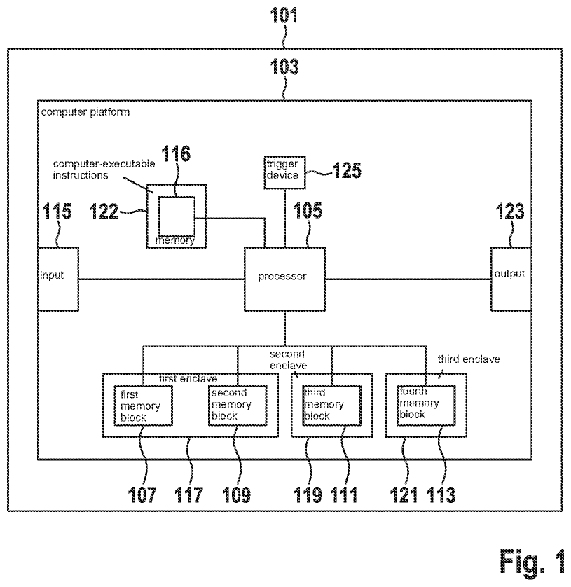

FIG. 1 shows a system 101 for monitoring a component of an effect chain for an at least partially automated driving function of a vehicle.

For the sake of clarity, the component of the effect chain is not shown.

System 101 comprises a computer platform 103. Computer platform 103 comprises a processor 105 and a first memory block 107, a second memory block 109, a third memory block 111, and a fourth memory block 113.

Furthermore, computer platform 103 comprises an input 115, which is set up to receive output data output by the component.

Furthermore, computer platform 103 comprises computer-executable instructions 116, which are executable by processor 105 in order to implement a first enclave 117 using first memory block 107 and second memory block 109, a second enclave 119 using third memory block 111, and a third enclave 121 using fourth memory block 113.

Computer-executable instructions 116 are stored in a memory 122 of computer platform 103.

First enclave 117 is a certificate enclave, which is set up to create a certificate for the component of the effect chain.

Computer platform 103 comprises an output 123, which is set up to output the certificate to the component. Following output of the certificate, output data from the component are received by way of input 115. Certificate component 117 is set up to check the output data received following output of the first certificate, on the basis of the certificate, in order to output a check result.

Computer platform 103 comprises a trigger device 125, which is set up to trigger one or more security actions on the basis of the check result.

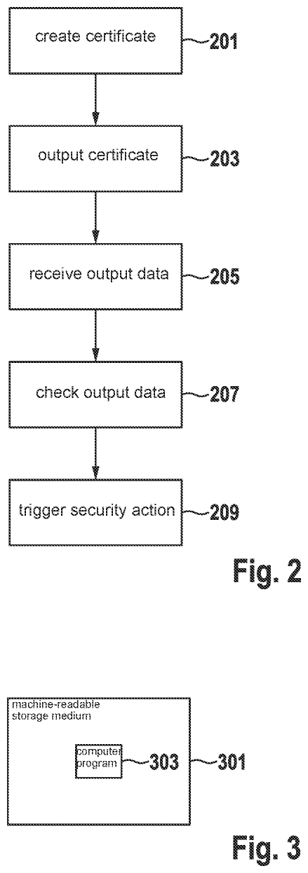

FIG. 2 shows a flow chart of a method for monitoring a component of an effect chain for an at least partially automated driving function of a vehicle, using a system according to the first aspect. The method comprises the following steps:

creating 201 a certificate for the component of the effect chain by way of the certificate enclave,

outputting 203 the certificate to the component by way of the output,

receiving 205 output data output by the component by way of the input,

checking 207 the output data received following output of the certificate, on the basis of the certificate, by way of the certificate enclave, in order to output a check result, triggering 209 a security action based on the check result, by way of the trigger device.

FIG. 3 shows a machine-readable storage medium 301 on which a computer program 303 is stored. Computer program 303 comprises commands that, in response to the execution of computer program 303 by a system according to the first aspect, cause the system to carry out a method according to the second aspect.

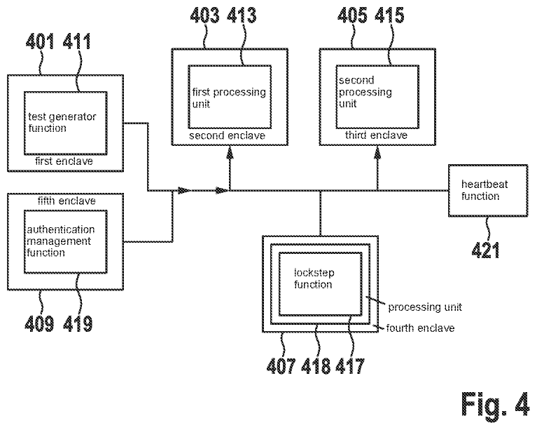

FIG. 4 shows a first enclave 401, a second enclave 403, a third enclave 405, a fourth enclave 407, and a fifth enclave 409. First enclave 401 provides a test generator function 411 for testing a component of an effect chain for an at least partially automated driving function of a vehicle. First enclave 401 is thus a test generator enclave.

Second enclave 403 implements a first processing unit 413. The second enclave is thus a processing unit enclave.

Third enclave 405 implements a second processing unit 415. Third enclave 405 is thus a processing unit enclave.

Fourth enclave 407 provides a lockstep function 417. Lockstep function 417 is implemented in a processing unit 418, which is implemented in fourth enclave 407.

Fifth enclave 409 provides an authentication management function 419. Fifth enclave 409 is thus an authentication management enclave.

Furthermore, a heartbeat module 421 is provided, which provides a heartbeat function. The five enclaves 401, 403, 405, 407, 409 and heartbeat function 421 are connected to one another and are implemented, for example, in accordance with one specific embodiment, in a computer platform of a system according to the first aspect.

According to one specific embodiment, heartbeat module 421 may be monitored by one or more of the five enclaves 401, 403, 405, 407, and 409.

For example, the five enclaves 401, 403, 405, 407, and 409 and heartbeat module 421 are implemented as an ASIC module.

What is claimed is:

1. A system for monitoring a component of an effect chain for an at least partially automated driving function of a motor vehicle, comprising:
a computer platform, including:
a processor;
one or more memory blocks;
an input configured to receive output data output from the component;
computer-executable instructions executable by the processor to implement one or more enclaves, using the one or more memory blocks, the one or more enclaves including a certificate enclave configured to create a certificate for the component of the effect chain;
an output configured to output the certificate to the component, the certificate enclave being configured to check the output data received following the output of the certificate, based on the certificate, to output a check result; and
a trigger device configured to trigger a security action based on the check result.

2. The system as recited in claim 1, wherein the one or more enclaves include a processing unit enclave, which is configured to implement a processing unit.

3. The system as recited in claim 2, wherein the processing unit is configured to provide a lockstep function.

4. The system as recited in claim 1, wherein the one or more enclaves include a time trigger enclave, which is configured to provide a time trigger function.

5. The system as recited in claim 1, wherein the one or more enclaves include a watchdog enclave, which configured to provide a watchdog function.

6. The system as recited in claim 1, wherein the one or more enclaves include an authentication management enclave, which is configured to provide an authentication management function.

7. The system as recited in claim 6, wherein the authentication management enclave is configured to provide a key management function.

8. The system as recited in claim 7, wherein the key management function is configured to provide a PUF for key management.

9. The system as recited in claim 1, wherein the one or more enclaves include a test generator enclave, which is configured to provide a test generator function for testing the component, for testing the component during runtime.

10. The system as recited in claim 1, wherein the one or more enclaves include a memory enclave, which is set up to provide a memory function for storing cryptographic data.

11. The system as recited in claim 1, wherein the computer platform is an ASIC.

12. The system as recited in claim 1, wherein the input is configured to receive configuration data for configuring the computer platform, the processor being set up to configure the computer platform based on the configuration data, during runtime.

13. The system as recited in claim 12, wherein the processor is set up to configure the computer platform based on the configuration data only if the configuration data are signed with a valid signature.

14. A method for monitoring a component of an effect chain for an at least partially automated driving function of a motor vehicle, using a system including a computer platform, the computer platform including:
a processor,
one or more memory blocks,
an input configured to receive output data output from the component,
computer-executable instructions executable by the processor to implement one or more enclaves, using the one or more memory blocks, the one or more enclaves including a certificate enclave configured to create a certificate for the component of the effect chain,
an output configured to output the certificate to the component, the certificate enclave being configured to check the output data received following the output of the certificate, based on the certificate, to output a check result; and
a trigger device configured to trigger a security action based on the check result;
the method comprising the following steps:
creating a certificate for the component of the effect chain using the certificate enclave;
outputting the certificate to the component using the output;
receiving output data output by the component by way of the input;
checking the output data received following output of the certificate, based on the certificate, using the certificate enclave, to output a check result; and
triggering a security action based on the check result, using the trigger device.

15. A non-transitory machine-readable storage medium on which is stored a computer program for monitoring a component of an effect chain for an at least partially automated driving function of a motor vehicle, using a system including a computer platform, the computer platform including:
a processor,
one or more memory blocks,
an input configured to receive output data output from the component,
computer-executable instructions executable by the processor to implement one or more enclaves, using the one or more memory blocks, the one or more enclaves including a certificate enclave configured to create a certificate for the component of the effect chain,
an output configured to output the certificate to the component, the certificate enclave being configured to check the output data received following the output of the certificate, based on the certificate, to output a check result; and
a trigger device configured to trigger a security action based on the check result;
the computer program, when executed by the system, causing the system to perform the following steps:
creating a certificate for the component of the effect chain using the certificate enclave;
outputting the certificate to the component using the output;
receiving output data output by the component by way of the input;
checking the output data received following output of the certificate, based on the certificate, using the certificate enclave, to output a check result; and
triggering a security action based on the check result, using the trigger device.
